(19) United States
(12) Patent Application Publication
(10) Pub. No.: US 2023/0216574 A1
(43) Pub. Date: Jul. 6, 2023

(54) SYSTEMS AND METHODS FOR MASSIVE MULTIPLE-INPUT MULTIPLE-OUTPUT ANTENNA CALIBRATION

(71) Applicant: Meta Platforms, Inc., Menlo Park, CA (US)

(72) Inventors: Mohammad Janani, San Jose, CA (US); Farbod Tabatabai, San Francisco, CA (US); Kodanda Ram Reddy Engala, Irving, TX (US)

(21) Appl. No.: 17/568,483

(22) Filed: Jan. 4, 2022

(51) Int. Cl. H04B 7/08; H04B 7/0413

(52) U.S. Cl. CPC H04B 7/08; H04B 7/0413

(57) ABSTRACT

A radio unit that is configured to perform calibration of its antennas for beamforming is disclosed. The radio unit may comprise a combiner. The combiner may be configured to cause the antennas to transmit calibration signals. The combiner may cause the calibration signals to rotate to different phases. The different phases may cause non-coherent combining of noise of the calibration signals when the calibration signals are combined. The combiner may combine the rotated calibration signals and the noise may be cancelled by the radio unit. The combiner may calibrate the antennas based on the combined calibration signals.

### TECHNOLOGICAL FIELD

The present application is directed to systems and methods for calibrating one or more antennas of a massive multiple-input multiple-output (MIMO) radio unit. More particularly, the present application is directed to systems and methods of reducing noise when calibrating the one or more antennas of a massive MIMO radio unit.

### BACKGROUND

Massive MIMO technology is recognized as a solution for the limited capacity of radio networks. However, transceiver lines of massive MIMO units may need to be calibrated frequently, as the transmitter and receiver lines may need to be synchronized for effective beamforming.

### BRIEF SUMMARY

This summary is provided to introduce a selection of concepts in a simplified form that are further described below in the Detailed Description. This summary is not intended to limit the scope of the claimed subject matter. The foregoing needs are met, to a great extent, by the exemplary embodiments of the present application described in more detail below.

According to one or more exemplary embodiments of the application, the antennas of a radio unit (e.g., a MIMO radio unit) may be calibrated for beamforming. To calibrate the antennas, the antennas may transmit calibration signals. A combiner of the radio unit may rotate the calibration signals to phases. The phases may be phases that may cause non-coherent combining of noise of the calibration signals in an instance in which the calibration signals are combined. The combiner may combine the calibration signals. Based on the combined calibration signals, the antennas may be calibrated.

According to an example embodiment of the application, a method may comprise rotating a plurality of calibration signals received from a plurality of antennas of a radio unit to obtain different phases, associated with the plurality of calibration signals, configured to cause non-coherent combining of noise of the plurality of calibration signals. The method may comprise combining the plurality calibration signals comprising the non-coherent combined noise. The method may comprise calibrating at least one antenna of the plurality of antennas based on the combined plurality of calibration signals.

According to an example embodiment of the application, a radio unit may comprise a plurality of antennas and at least one combiner. The combiner may be configured to receive a plurality of calibration signals transmitted from the plurality of antennas. The combiner may be configured to rotate the plurality of calibration signals to obtain different phases, associated with the plurality of calibration signals, to cause non-coherent combining of noise of the plurality of calibration signals. The combiner may be configured to combine the plurality of calibration signals comprising the non-coherent combined noise. The radio unit may calibrate at least one antenna of the plurality of antennas based on the combined plurality of calibration signals.

According to an example embodiment of the application, a combiner may be configured to rotate a plurality of calibration signals received from a plurality of antennas of a radio unit to obtain different phases, associated with the plurality of calibration signals, configured to cause non-coherent combining of noise of the plurality of calibration signals. The combiner may be configured to combine the plurality calibration signals comprising the non-coherent combined noise. The combiner may calibrate at least one antenna of the plurality of antennas based on the combined plurality of calibration signals.

There has thus been outlined, rather broadly, certain embodiments in order that the detailed description thereof may be better understood, and in order that the present contribution to the art may be better appreciated.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 illustrates example beamforming techniques according to an exemplary embodiment.

FIG. 2 illustrates a diagram of an example time division duplex (TDD) transceiver (TRx) line according to an exemplary embodiment.

FIG. 3 illustrates an example calibration feedback circuit according to an exemplary embodiment.

FIG. 4 illustrates antenna calibration using partial bandwidth according to an exemplary embodiment.

FIG. 5 illustrates antenna calibration using full bandwidth according to an exemplary embodiment.

FIG. 6 illustrates a spread phase combiner according to an exemplary embodiment.

FIG. 7 illustrates a spread phase combiner according to another exemplary embodiment.

FIG. 8 illustrates an example noise enhancement solution according to an exemplary embodiment.

FIG. 9 illustrates example circuits for noise enhancement solutions according to an exemplary embodiment.

FIG. 10 illustrates an example method for solving noise enhancement according to an exemplary embodiment.

FIG. 11 illustrates an example radio unit according to an exemplary embodiment.

### DETAILED DESCRIPTION OF THE ILLUSTRATIVE EMBODIMENTS

A detailed description of the illustrative embodiment is discussed in reference to various figures, embodiments, and aspects herein. Although this description provides detailed examples of possible implementations, it should be understood that the details are intended to be examples and thus do not limit the scope of the application.

Reference in this specification to “one embodiment,” “an embodiment,” “one or more embodiments,” “exemplary embodiments,” “an aspect” or the like may mean that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other embodiments.

Generally, the present application describes exemplary embodiments having improved methods of calibrating massive MIMO radio unit antenna(s). Existing calibration methods may suffer from reduced accuracy as a result of the coherent combining of noise from calibration signals. The described methods of the exemplary embodiments address this shortcoming by rotating calibration signals to phases such that noise combines non-coherently, allowing for more accurate calibration of one or more antennas (e.g., MIMO antennas).

According to the present application, it is understood that any or all of the systems, methods and processes described herein may be embodied in the form of computer executable instructions, e.g., program code, stored on a computer-readable storage medium which instructions, when executed by a machine, such as a computer, server, transit device or the like, perform and/or implement the systems, methods and processes described herein. Specifically, any of the steps, operations or functions described herein may be implemented in the form of such computer executable instructions. Computer readable storage media may include volatile and nonvolatile, removable, and non-removable media implemented in any method or technology for storage of information, but such computer readable storage media does not include signals. Computer readable storage media may include, but are not limited to, random access memory (RAM), read only memory (ROM), electrically erasable programmable read-only memory (EEPROM), flash memory or other memory technology, compact disc read only memory (CD ROM), digital versatile disks (DVD) or other optical disk storage, magnetic cassettes, magnetic tape, magnetic disk storage or other magnetic storage devices, or any other physical medium which may be used to store the desired information and which may be accessed by a computer.

MIMO technology is designed to multiply a radio link's capacity through the use of multiple transmitting and receiving antennas. Using the multiple antennas and multi-path propagation, more than one data signal may be sent and/or received simultaneously over the same radio channel. MIMO may be used in Institute of Electrical and Electronics Engineers (IEEE) 802.11ac (W-Fi), IEEE 802.11n (W-Fi), Worldwide Interoperability for Microwave Access (WiMAX), High Speed Packet Access Plus, Third Generation (HSPA+) (3G), Fourth generation (4G) Long Term Evolution (4G LTE), and Fifth generation (5G) Long Term Evolution (5G LTE) and other communication technologies. MIMO may also be used for power line communication for 3 wire deployments, as part of HomePlug AV2 specification and International Telecommunication Union (ITU) G.hn standard.

Massive MIMO is an extension of the MIMO technique, with better spectrum efficiency and increased throughput by combining receiver and transmitter antennas. Massive MIMO antennas are capable of augmenting system capacity, improving throughput, enhancing spectral efficiency, increasing resistance, and reducing fading. Massive MIMO technology is used for both mobile devices and base stations.

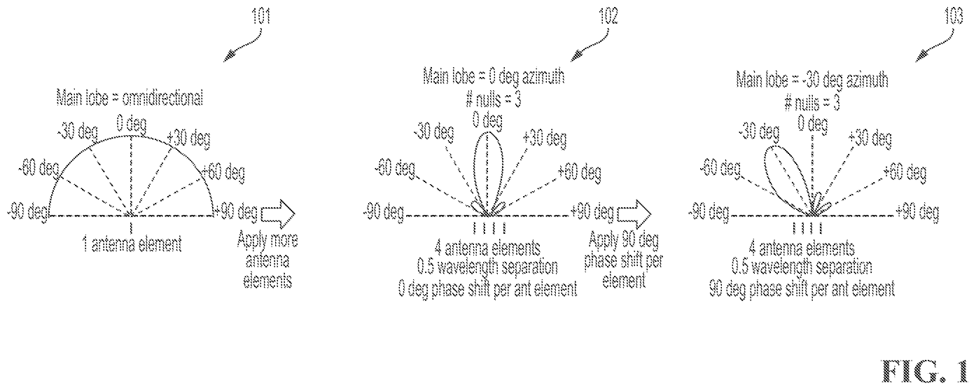

Beamforming is a signal processing technique for directional signal transmission and/or reception. FIG. 1 shows example beamforming techniques according to an exemplary embodiment. In beamforming, antenna elements may be combined in such a way that signals at particular angles experience constructive interference while others experience destructive interference. To change directionality, a radio unit may control the phase and relative amplitude of the signal at each transmitter, in order to create a pattern of constructive and destructive interference in the wavefront. The constructive interference forms what is known as “lobes”.

For example, FIG. 1 shows how a radio unit 101 with 1 antenna broadcasts in a 180 degree angle, forming an omnidirectional main lobe. Yet, when more antennas are present, such as in radio unit 102 which has 4 antennas, it is possible to broadcast at a wavelength separation, such as 0.5, and with a degree phase shift per antenna, such as 0 degrees, such that destructive interference may occur at certain angles. For example, radio unit 102 broadcasts such that destructive interference occurs at −90 degrees, 90 degrees, −30 degrees, and 30 degrees from a 0 degree azimuth. In other directions, such as 45 degrees and −45 degrees from the 0 degree azimuth and along the 0 degree azimuth, constructive interference (e.g., lobes) occurs.

As another example, radio unit 103 is shown having 4 antennas that are broadcasting with a 0.5 wavelength separation and with 90 degrees phase shift per antenna. Radio unit 103 has constructive interference (e.g., lobes) at −30 degrees, 30 degrees, and 50 degrees from the 0 degree azimuth. Radio unit 103 has destructive interference in other directions, such as along the 0 degree azimuth, 30 degrees, −90 degrees, and 90 degrees from the 0 degree azimuth.

Signals from different transmitters may be amplified by different weights. For example, a transmitter pointing in the intended direction may be amplified by a higher weight than another transmitter of a radio unit pointing in another direction. When receiving signals, information from different antennas may be combined in a way that the expected pattern of radiation is preferentially observed.

Massive MIMO radio unit transceiver lines may need to be calibrated frequently as the transmitter and/or receiver lines may need to be synchronized (e.g., having same phase and magnitude) for effective beamforming. Otherwise, there may be an error in the direction of the transmission. Synchronization also may improve beamforming gain, prevent sidelobes, and/or improve beamforming performance. Calibrating may involve the antennas transmitting calibration signals, receiving and/or combining the calibration signals in a particular direction, observing the strength of the combined calibration signal, and adjusting the phase and/or magnitude on which the antennas are transmitting to direct the signals in a desired direction and may minimize side lobes. A side lobe may be an unintended transmission caused by at least a portion of a transmitted signal not going toward the intended direction. Existing approaches of calibration that utilize combiners may have the effect of combining noise from calibration signals coherently. The coherent combining of the noise, in these existing approaches, may increase the noise floor, which may reduce accuracy of the calibration as it may lower the signal to noise ratio, making it difficult to determine the phase and magnitude of the combined calibration signal.

The exemplary embodiments of the present application enables calibration of antennas of massive MIMO radio units with accuracy higher than traditional/existing methods. The accuracy may be achieved by reducing noise of the calibration signals by using transmission feedback signals (e.g., calibration signals) with different phases so that noise may be combined non-coherently. Non-coherent combining of noise may be combining of noise from different sources or non-correlated sources.

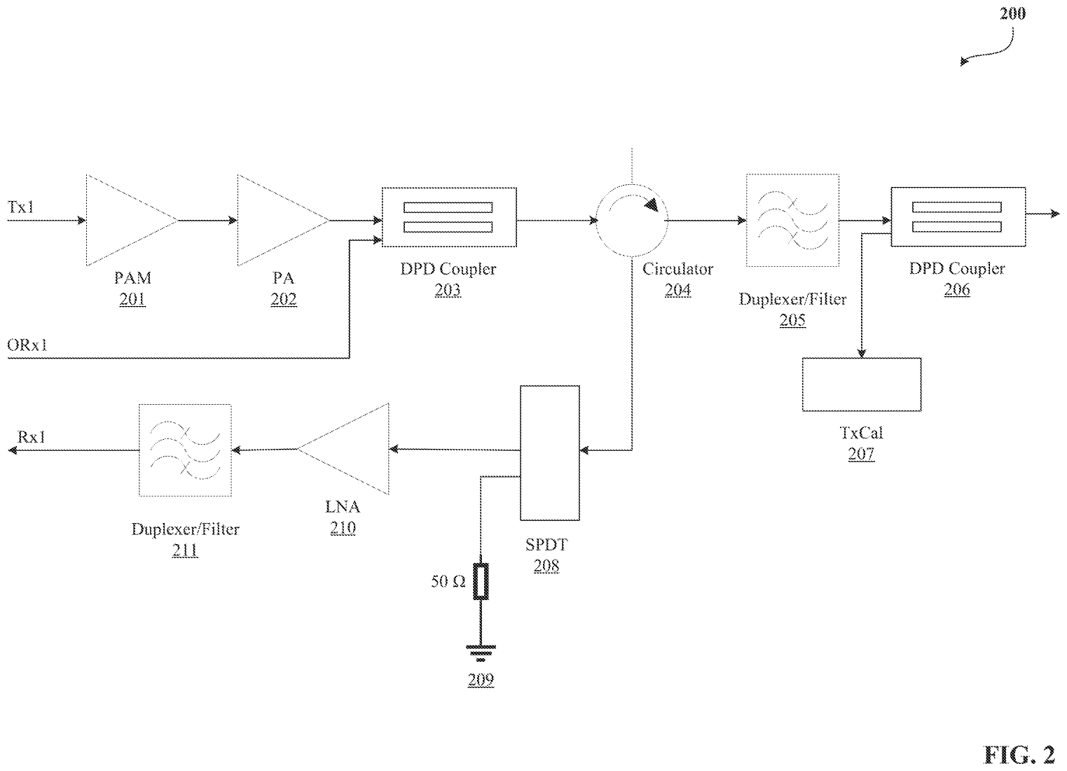

FIG. 2 is a diagram of an example time division duplex (TDD) transceiver (TRx) line 200. A TDD TRx may transmit and/or receive at different frequencies and in opposite directions. The TDD TRx line 200 may be an antenna(s) of a radio unit, such as a massive MIMO radio unit and/or a router. The TDD TRx line 200 may include a transmitter Tx1. The transmitter Tx1 may transmit a signal. The signal may be a calibration signal, sent to calibrate the transmitter Tx1 for beamforming. The signal may be sent through a pulse amplitude modulation (PAM) component 201. The PAM component 201 may modulate the signal, such that the signal is encoded in the amplitude of a series of signal pulses. The signal may be amplified by a power amplifier (PA) 202. The amplified signal may be received by a digital pre-distortion (DPD) coupler 203 (also referred to herein as coupler 203). The DPD coupler 203 may take a sample version of PA 202 output for digital pre-distortion processing. The DPD coupler 203 may combine the amplified signal with a signal from an observation receiver (ORx1) to reduce distortion created by the PA 202.

The combined signal may be transmitted to a circulator 204, which may redirect the Tx1 and Rx1 signals to their corresponding branches (e.g., Tx1 to PA 202 and Rx1 to LNA 210 and PA 202) and control the direction of the flow of the signal. The circulator 204 may send the combined signal to a duplexer/filter 205. The duplexer/filter 205 may enable antenna sharing between the transmit and/or receive paths of the radio unit, such as by isolating the receive path from interference caused by the transmit signal path and suppressing out-of-band signals on both paths.

The duplexer/filter 205 may send the combined signal to a DPD coupler 206. The DPD coupler 206 may combine the combined signal with signals from other antenna(s) of the radio unit. The DPD coupler 206 may send the combined signal to a calibration transmitter (TxCal) 207. Although FIG. 2 shows the DPD coupler 206 after the duplexer/filter 205, the DPD coupler 206 may be anywhere on Tx1 after the circulator 204 where Tx1 has a common path with a receiver Rx1, such as before the duplexer/filter 205. The DPD coupler 206 may be in an antenna frontend unit (AFU) close to an antenna(s).

The TDD TRx line 200 may include the receiver Rx1. The receiver Rx1 may be part of an antenna(s). The receiver Rx1 and the transmitter Tx1 may be components of the same antenna(s). The receiver Rx1 may be a dedicated receiver.

The circulator 204 may send the combined signal to a single pole double throw (SPDT) switch 208 of the receiver Rx1. The circulator 204 may receive signals from antenna and direct towards LNA 210 and/or Rx1. The circulator 204 may send the combined signal to the SPDT switch 208 and the duplexer/filter 205 simultaneously.

The SPDT switch 208 may be connected to a resistor and a ground point 209. The SPDT switch 208 may send the combined signal to a low noise amplifier (LNA) 210. The LNA 210 may amplify the combined signal. The LNA 210 may send the amplified combined signal to a duplexer/filter 211. The duplexer/filter 211 may send the signal to an analog-to-digital (ADC) convertor, such as for digitization and/or to a Baseband processing unit.

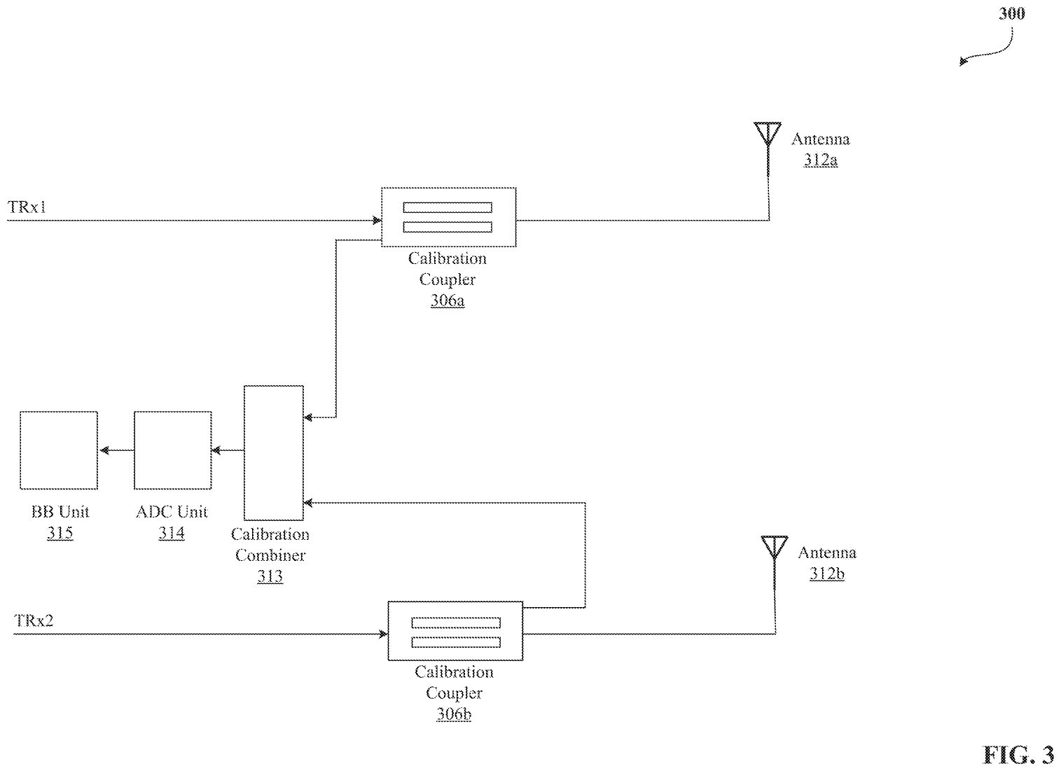

FIG. 3 is a diagram of an example calibration feedback circuit 300. The calibration feedback circuit 300 may include a transceiver TRx1. TRx1 may be the same as or similar to the TDD TRx line 200 in FIG. 2. TRx1 may transmit a signal to a calibration coupler 306a. The calibration coupler 306a may also receive a signal from an antenna 312a. TRx1 may be of a different antenna than antenna 312a. The calibration coupler 306a may combine the signal from TRx1 and the signal from the antenna 312a.

The calibration coupler 306a may send the combined signal to a transmitter calibration combiner 313. The transmitter calibration combiner 313 may also receive a signal from another transceiver TRx2. TRx2 may be of a different antenna than TRx1 and/or antenna 312a. Tx2 may include a calibration coupler r 306b that receives a signal from an antenna 312b. The signal from the antenna 312b may be combined with the signal from Tx2 at a calibration coupler 306b. The combined signal may be sent from the calibration coupler 306b to the transmitter calibration combiner 313.

The transmitter calibration combiner 313 may collect and combine the signal from TRx1, the signal from TRx2, and/or the signal from one or more other transceivers TRxn, such as of a radio unit. The noise from the different transceivers TRx1, TRx2, and/or TRxn may combine coherently when combined by the transmitter calibration combiner 313. The noise may combine coherently because phase noise of a local oscillator (LO) may come/originate from a same source. When coherently combined, the noise may be enhanced by a factor of 20 log 10(Ntrx), where Ntrx is the number of transceivers and/or antennas of a radio unit.

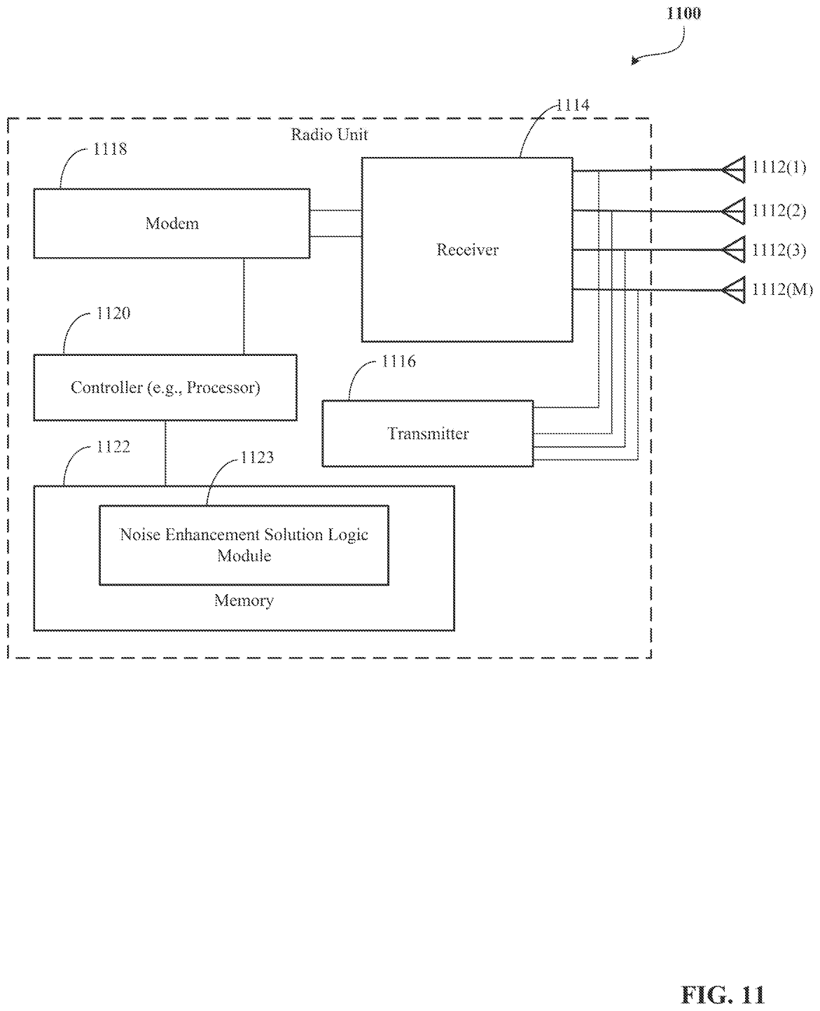

The transmitter calibration combiner 313 may send the combined signal to an ADC unit 314. The ADC unit 314 may make a digitized version of the combined signal. The ADC unit 314 may send an indication of the received signal to another device or component of the radio unit (e.g., radio unit 1110 of FIG. 11), such as a baseband (BB) unit 315. The BB unit 315 may perform further processing of the combined signal, such as to estimate its phase and magnitude. The device or component (e.g., the BB unit 315) may analyze the signal and calibrate the radio unit based on the signal.

Because of the enhanced noise, the device or component may not be able to calibrate the radio unit very accurately. For example, the calibration may be limited to accuracy of a few degrees for phase accuracy.

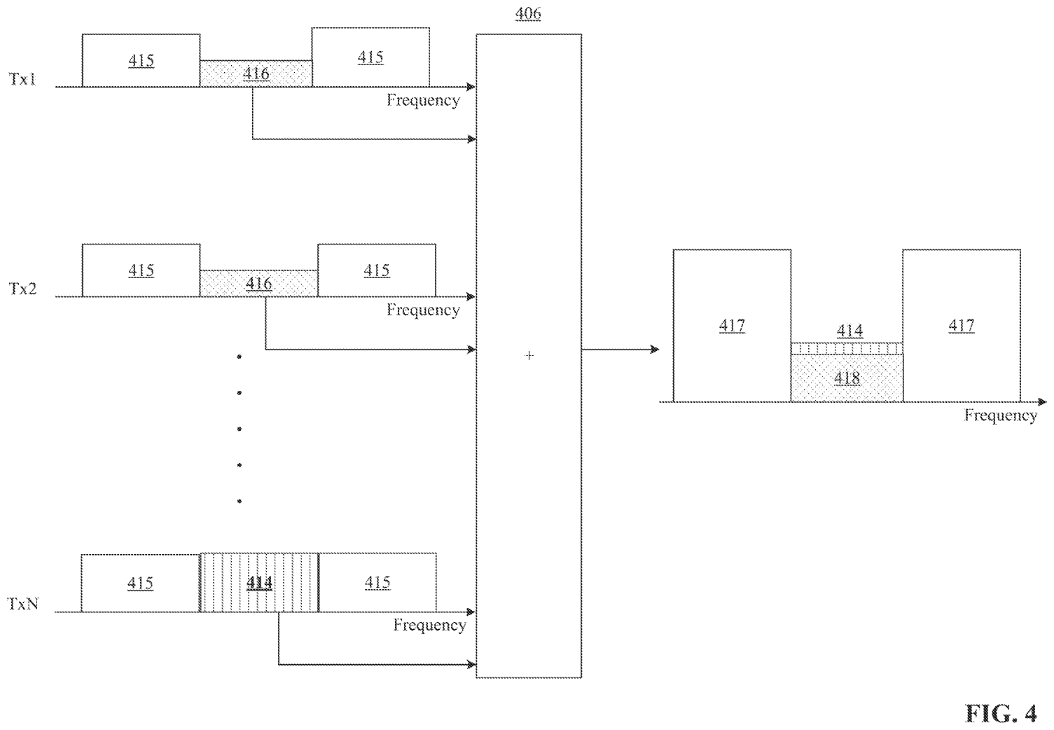

There are two main approaches to antenna calibration according to the exemplary embodiments. FIG. 4 is an illustration of a first approach—antenna calibration using partial bandwidth. According to this approach, part of the bandwidth, resource blocks 414, may be used for calibration and part of the bandwidth, resource blocks 415, may be used for normal traffic (e.g., data signals). In instances in which partial bandwidth may be used for calibration, each of the antennae and/or transmission lines Tx1, Tx2, TxN, etc. may be transmitting using resource blocks 415. On the calibration part of the bandwidth, calibration resource blocks 414, one or more antenna (TxN) may be calibrated simultaneously. Sharing of the bandwidth by multiple antennas may be an effective technique due to the high number of transmission lines, the frequency/power options, and the digital front end (DFE) configurations of a massive MIMO radio unit.

Even though some of the transmission lines Tx1, Tx2, TxN may not be calibrated or transmitting on the calibration resource blocks 414, they may create noise 416 in the calibration resource blocks. The noise 416 may be the result of LO noise or other leaked noise. The transmissions may be combined by a calibration combiner 406 (e.g., DPD coupler 206 in FIG. 2 and/or calibration couplers 306a, 306b in FIG. 3). The data signals may combine to form combined resource blocks 417. However, the noise 416 in the calibration resource blocks 414 may combine coherently because it may originate from a LO coming from a same source. When combined, the noise may be enhanced by a factor of 20 log 10(Ntrx) to yield enhanced noise 418. The enhanced noise may also limit the accuracy of the calibration because it may reduce the calibration signal to noise level and reduce the accuracy estimation of phase and magnitude of the calibration signal.

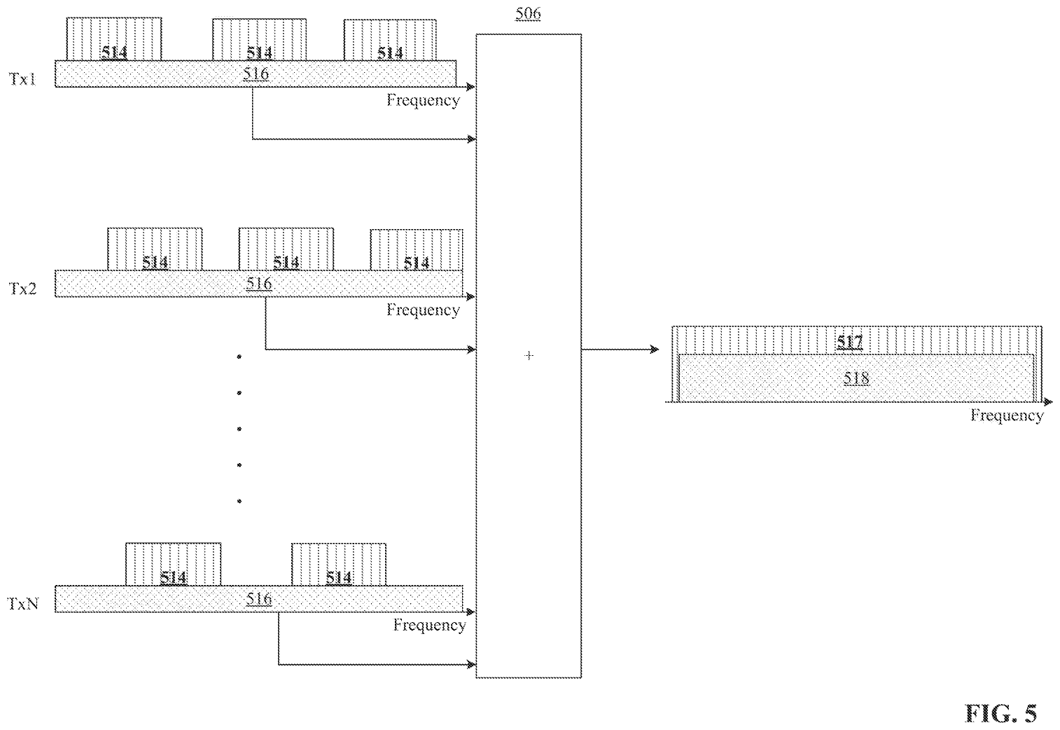

FIG. 5 is an illustration of a second approach—antenna calibration using full bandwidth. According to this approach, all of the bandwidth may be used for calibration. In instances in which all bandwidth may be used for calibration, a sub-group of antenna(s) and/or transmission lines Tx1, Tx2, TxN, etc. may be calibrated simultaneously. For example, in an instance in which a radio unit has 64 antennae, 8 may be calibrated at a given bandwidth. The transmission lines Tx1, Tx2, TxN may use resource blocks 514 of the bandwidth for calibration.

When calibrating using partial bandwidth, it may not be possible to turn off power amplifiers (PA)s. When calibrating using partial bandwidth, the power amplifiers (PA)s on the antennae that may not be calibrated may be turned off to avoid LO leakage. Yet, noise may leak from PA's that are being calibrated simultaneously and which may be unable to be turned off.

The signals may be combined by a calibration combiner 506 (e.g., DPD coupler 206 in FIG. 2 and/or calibration couplers 306a, 306b in FIG. 3). The calibration signals may combine normally (e.g., similar to combined resource blocks 417). The LO noise 416 may combine coherently and be enhanced by a factor of 20 log 10(Ntrx) because the LO noise may come from a same source. The enhanced noise 518 may cause a dynamic range issue. The enhanced noise 518 may also limit the accuracy of the calibration.

As an illustrative example, resource blocks 1-10 may be assigned for calibration of transmission antenna 1 (TxAnt1) of a radio unit. All other antennas of the radio unit may be using resource blocks 11-100 to transmit normal traffic (e.g., data signals). As such, in this example only TxAnt1 may be transmitting on resource blocks 1-10 (e.g., transmitting a calibration training sequence), while the other antennas may be silent resource blocks 1-10. Although the other antennas may be logically silent, these antennas may physically inject noise in the calibration resource blocks 1-10.

The noise may be represented by an error vector magnitude (EVM). The EVM may represent an in-band noise floor. The EVM may be set to 2.5% (e.g., −32 dBc, in which dBc denotes decibels relative to a carrier). The radio unit may have 64 antennas. The noise floor created by a calibration combiner may be added to the calibration training sequence. The EVM noise may mostly be from phase noise (generated by LO's), clipping noise (generated by a BB unit), and/or coherent combination of LO phase noise/clipping noise. Therefore, using the noise enhancement formula of 20 log 10(Ntrx), the noise may be anywhere in the range of 10 log 10(64)=18 dBc to 20 log 10(64)=36 dBc. This level of noise may result in degrading or flooding of the training sequence (e.g., the calibration training sequence). With non-coherent combining or independent clipping noise, the noise floor may be raised from −32 dBc to −14 dBc, derived from −32 dBc −18 dBc (where 18 dBc is a positive value). If the EVM is set to −42 dBc, coherent combining may raise the floor as high as −42 dBc+36 dBc=−6 dBc (EVM+high end of range). A strong training sequence may be needed to lower the noise level. A strong training sequence may be one that has the ability to archive processing gain in a BB unit. Another problem associated with traditional calibration techniques is that data from other data resource blocks of all antenna may be combined via a combiner to process the data by one reference receiver and such that the data has a similar reference calibration path. The combined data may consume the dynamic range of an observation receiver (e.g., ORx in FIG. 1).

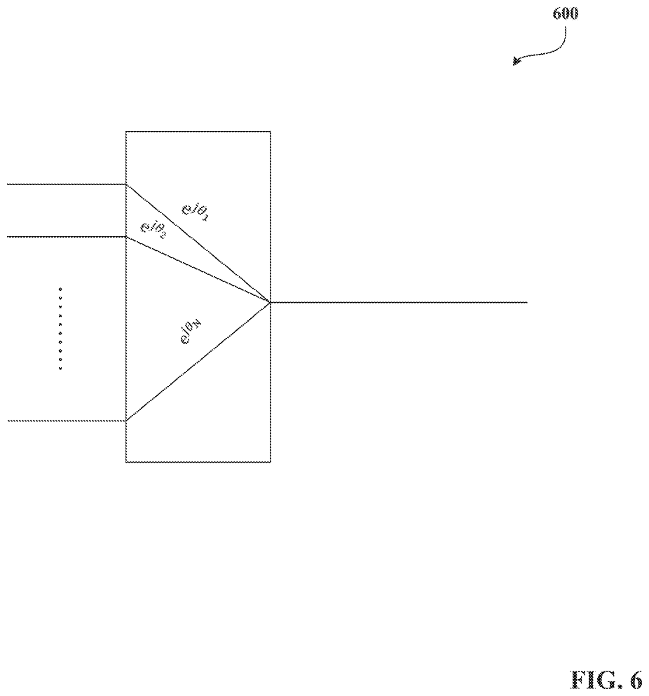

FIG. 6 is an exemplary illustration of a spread phase combiner 600 (i.e., also referred to herein as splitter 600). The spread phase combiner 600 may reduce enhanced noise in antenna calibration by combining calibration signals at different phases. By causing the calibration signals to have different phases during combination, the spread phase combiner 600 may cause non-coherent combining of noise, including phase noise and clipping noise. The different phases of the calibration signals may also suppress phase noise due to the addition of phase difference.

The phases of the signals may be determined by calculating phases that when summed may yield a noise level of 0. The phase of each input port/output port pair (e.g., transfer function) of the radio unit may be described as 6i, where i is a number from 1 to N, where N is the number antenna/transceivers. For example, as shown in FIG. 6, the spread phase combiner 600 may cause the first transfer function to have a phase of e^{jθ}^{₁} during combination, the second transfer function to have a phase of e^{jθ}^{₂} during combination, and the Nth transfer function to have a phase of e^{jθ}^{_{N}} during combination. To achieve non-coherence, the sum of the transfer functions equals zero, using the formula Σᵢ₌₁^{N} αᵢe^{jθi}=0, where α is the magnitude of a path and θ is the phase of the path.

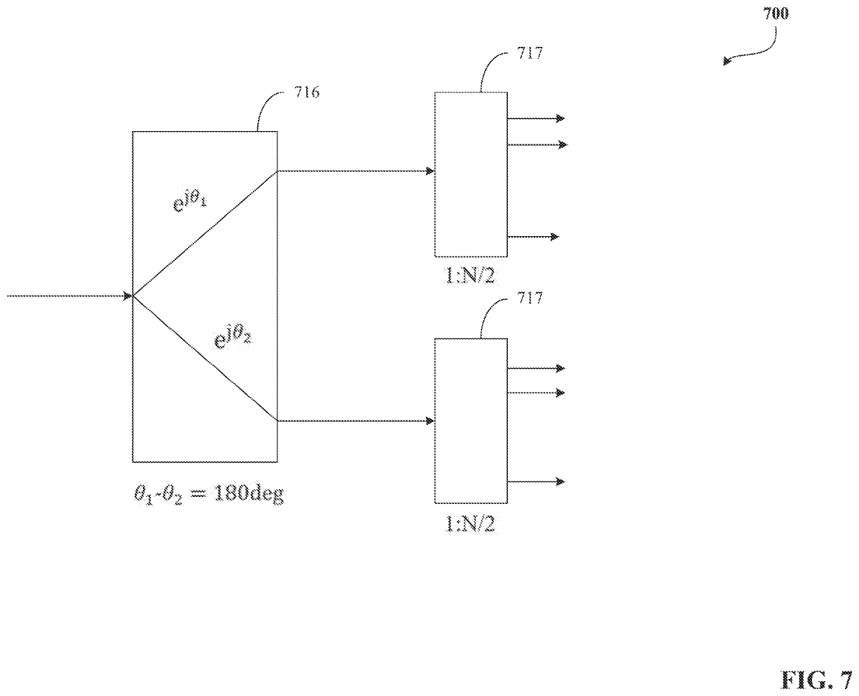

FIG. 7 is an exemplary illustration of another spread phase combiner 700 (i.e., also referred to herein as splitter 700). The spread phase combiner 700 may include a first stage combiner 716 that may cause the phase of each input port/output port pair (e.g., transfer function) of a radio unit to split into two signals differing by 180 degrees (θ1−θ2=180 degrees). The spread phase combiner 700 may include two second stage combiners 717. During calibration, the second stage combiners 717 may combine signal samples from TRx lines. During Rx calibration, the second stage combiners 717 may split reference signals towards TRx lines. The two second stage combiners 717 may further split each signal from first stage combiner 716 into 1:N/2 signals, where N is the number of antennas of the radio unit.

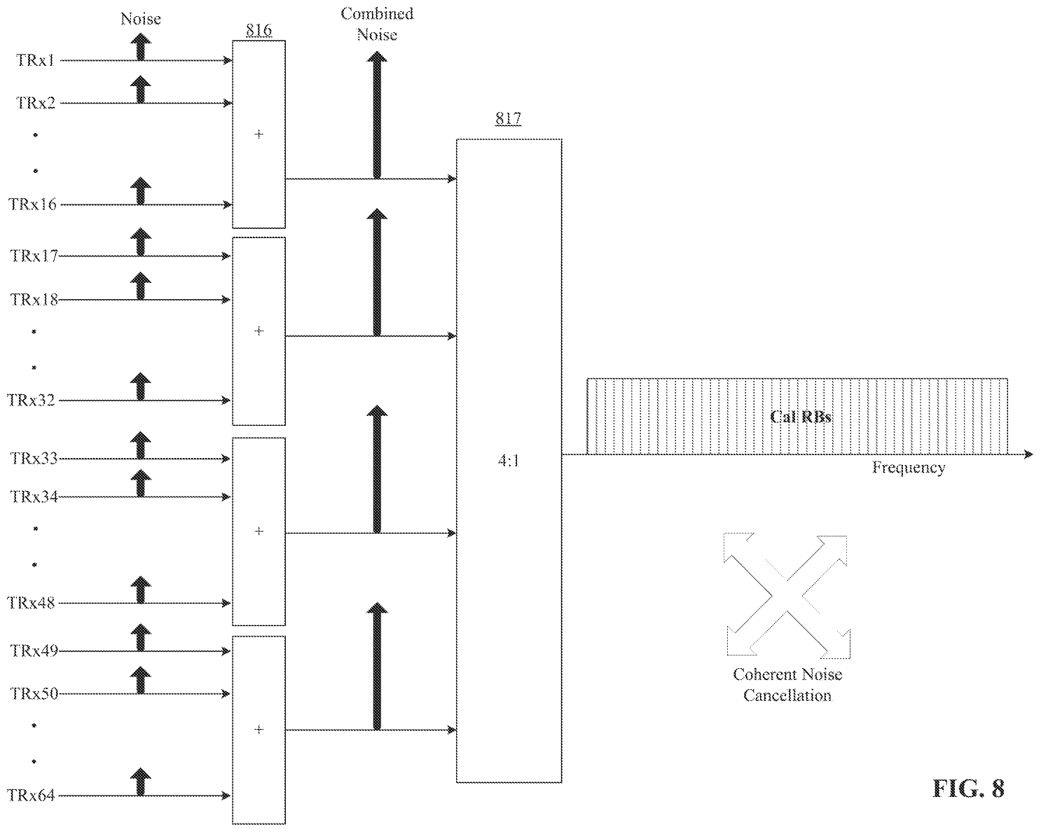

Alternatively, the first stage combiner 716 may split the input port/output port pairs of the radio unit into signals having differences of 0 degrees, 90 degrees, 180 degrees, or 270 degrees. The second stage combiners 717 may split the signals from the first stage combiner 716 into 1:N/4 signals. The phases of the transfer functions may be jumbled or shifted by a constant value. The phases of the transfer functions may be jumbled or shifted by a spread phase unit (e.g., spread phase unit 716 in FIG. 7 and/or spread phase combiner 817 in FIG. 8).

A similar method may be performed for the ports of a first stage combiner, or M ports. The first stage combiner 716 may split each transfer function into signals having phase differences of 0,

$$\frac{2 π}{M} , {2}^{*} \frac{2 π}{M} , … , {( M - 1 )}^{*} \frac{2 π}{M} .$$

The second stage combiners 717 may split the signals from the first stage combiner 716 into N/M signals. M (the number of ports) may be set equal to N (the number of antennas/transceivers). The second stage combiner 717 may not be used.

FIG. 8 illustrates an example noise enhancement solution according to an exemplary embodiment. The noise enhancement solution may be for antenna calibration performed using full or partial resource blocks. A radio unit may have any number of transceivers (TRx), such as, for example, 64 transceivers. The transceivers may be calibrated. Calibrating the transceivers may include transmitting calibration signals through first stage combiners 817 (e.g., first stage combiner 716). The first stage combiners 816 may combine the calibration signals. A spread phase combiner (e.g., spread phase combiner 600 in FIG. 6, spread phase combiner 700 in FIG. 7) may rotate (e.g., phase shift) the combined calibration signals. The spread phase combiner may rotate the combined calibration signals such that noise from the combined calibration signals may combine non-coherently. For example, the spread phase combiner may spread the phase of the combined calibration signals such that they have a difference of 360/m, where m is the number of signals being combined. FIG. 8 shows 4 combined calibration signals being combined (e.g., combined noise in FIG. 8) by a second stage combiner 817 (e.g., second stage combiners 717). As such, the combined calibration signals may be spread such that they differ by 90 degrees. The non-coherent combining may reduce noise. In this manner, noise in the combined calibration signals may be cancelled and/or not enhanced, by the radio unit, due to the phase spreading. Although FIG. 8 shows the second stage combiner 817 being a 4:1 combiner (combining 4 signals into 1), the second stage combiner 817 may be a 2:1 combiner (combining 2 signals into 1), an 8:1 combiner (combining 8 signals into 1), or another ratio combiner, as examples.

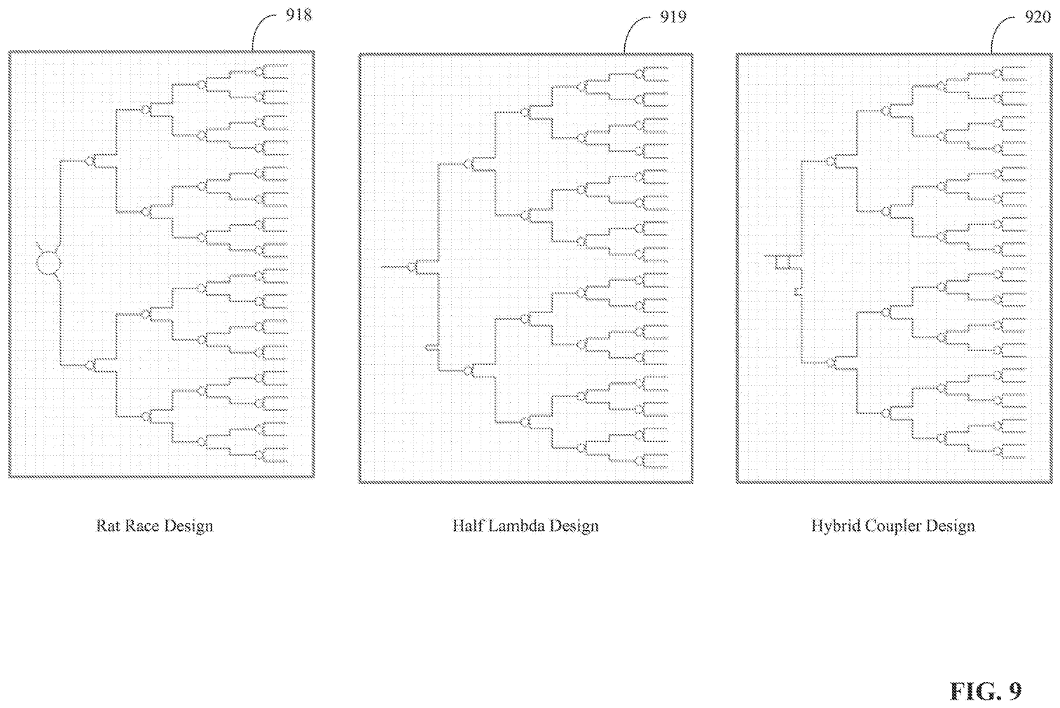

FIG. 9 illustrates example circuits 918, 919, and 920 for noise enhancement solutions according to an exemplary embodiment. The exemplary circuits 918, 919, and 920 may be exemplary embodiments of spread phase combiners. The circuits 918, 919, 920 may include a 1:2 spread phase splitter, a 1:32 spread phase splitter, and a 1:64 spread phase splitter, which may be implemented by a radio unit. Other splitters may also be utilized by an exemplary embodiment. Circuit 918 may be a Rat Race design. Circuit 919 may be a Half Lambda design. Circuit 920 may be a Hybrid Coupler design.

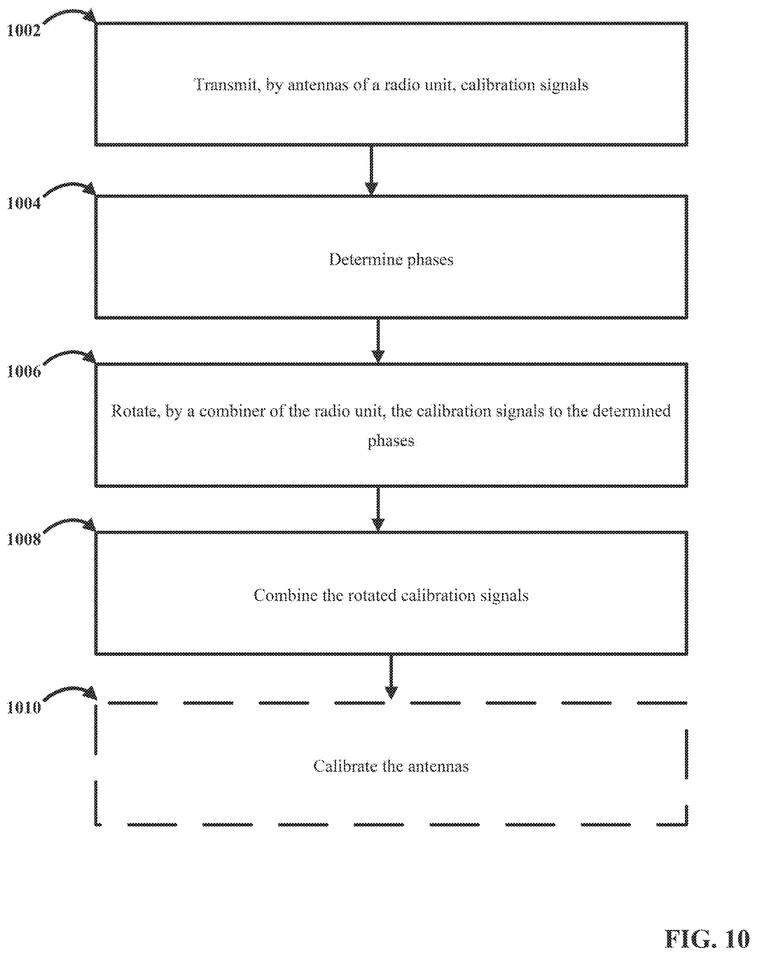

FIG. 10 shows an example method for solving noise enhancement according to an exemplary embodiment. The method of FIG. 10 may be a method of calibrating antennas of a radio unit (e.g., radio unit 1100 of FIG. 11), such as a massive MIMO radio unit or a beamformer. The method of FIG. 10 may be a more accurate calibration technique than traditional/existing methods. The method of FIG. 10 may enable reduction of noise from signals at one or more antennas (e.g., MIMO antennas).

At step 1002, a plurality of antennas may transmit calibration signals. The calibration signals may be transmitted using all bandwidth available to the radio unit (e.g., antenna calibration using full bandwidth). The calibration signals may be transmitted using a portion of bandwidth available to the radio unit (e.g., antenna calibration using partial bandwidth). Other portions of the bandwidth may be used for normal traffic (e.g., data traffic).

At step 1004, a plurality of phases may be determined. The plurality of phases may be phases associated with the calibration signals. The plurality of phases may be determined by a combiner of the radio unit. The combiner may be DPD coupler 206, calibration coupler 306a, calibration coupler 306b, first stage combiners 816 or any other suitable combiner described herein. The plurality of phases may be determined by a processor (e.g., controller 1120 of FIG. 11) of the radio unit. A component of the radio unit, such as a spread phase combiner, may determine phases that, when combined, may cause non-coherent combining of noise of the calibration signals. The noise may be phase noise and/or clipping noise, as examples. Phases that cause non-coherent combining of the noise may be phases whose transfer functions, when summed by the radio unit, equal zero.

At step 1006, the plurality of calibration signals may be rotated to the determined phases. The signals may be rotated by the combiner (e.g., of the radio unit). Rotating the signals may include causing the signals to propagate at different angles. The angles may differ by 360/m, where m is the number of calibration signals and/or the number of antennas being calibrated. The angles may differ by 90 degrees.

Rotating the calibration signals may comprise splitting each calibration signal into two or more signals having different phases. Rotating the signals may include splitting the split calibration signals again (e.g., into two or more other signals). Splitting the calibration signals again may allow for a faster calibration process.

At step 1008, the rotated calibration signals may be combined. The signals may be combined by the combiner. The combiner may be DPD coupler 206, calibration coupler 306a, calibration coupler 306b, first stage couplers 816. The signals may be combined by a secondary combiner of the radio unit. The secondary combiner may be second stage combiner 817. When the signals are combined, the noise may combine non-coherently. The noise that may be combined non-coherently may be cancelled by the radio unit. Summation of coherent noise may cause subtraction of the noise when it is combined. For example, noise may have a phase of 0 and a magnitude of 1 when entering a 1:2 spreading phase combiner. The combiner may change/rotate the phase of one transmission to −180, which may convert the magnitude to −1. When noise from various transmission is combined, the magnitudes of 1 and −1 may be added, equaling 0 and cancelling out the noise.

Optionally, at step 1010, the antennas may be calibrated. The antennas may be calibrated based on the combined signals. Due to the noise cancellation, the calibration may be more accurate than with traditional/existing methods/techniques.

FIG. 11 shows an example radio unit 1100 according to an exemplary embodiment. The radio unit 1100 may be configured to perform massive MIMO communication techniques. The radio unit 1110 may be a radio transceiver, a base station, base transceiver station (BTS) (e.g., a NodeB, an Evolved UMTS Terrestrial Radio Access Network Node B (eNodeB)), etc. The radio unit 1100 may be configured to perform beamforming. The radio unit 1110 may communicate with one or more computing devices (e.g., mobile devices (e.g., cellular phones, mobile tablets, laptops), personal computers, servers, etc.) The radio unit 1100 may include a receiver 1114, a radio transmitter 1116, a modem 1118, a controller 1120 (e.g., a processor), and a memory 1122. The radio receiver 1114 may be configured to receive signals detected by the plurality of antennas 1112(1)-1112(M) and provides antenna-specific receive signals to the modem 1118. The receiver 1114 may include a plurality of individual receiver circuits, each for a corresponding one of a plurality of antennas 1112(1)-1112(M) and which may output a receive signal associated with a signal detected by a respective one of the plurality of antennas 1112(1)-1112(M).

The transmitter 1116 may be configured to transmit signals (e.g., signals weighted from application of beamforming weights) to corresponding ones of the plurality of antennas 1112(1)-1112(M) for transmission. The transmitter 1116 may include individual transmitter circuits that provide signals to corresponding ones of a plurality of antennas 1112(1)-1112(M) for transmission.

The controller 1120 may be configured to provide data to the modem 1118 to be transmitted. The controller 1120 may process data recovered by the modem 1118 from received signals. The controller 1120 may perform other transmit and/or receive control functionality. In some exemplary embodiments, there may be analog-to-digital converters (ADCs) and digital-to-analog converters (DACs) in the various signal paths to convert between analog and digital signals.

The memory 1122 may store data used for the techniques described herein. The memory 1122 may be separate or part of the controller 1120. In addition, instructions for noise enhancement solution logic module 1123 (also referred to herein noise enhancement solution logic 1123 or process logic 1123) may be stored in the memory 1122 for execution by the controller 1120. The controller 1120 may supply the phases, described herein, to the modem 1118 and the modem 1118 may rotate the calibration signals, described herein, before they are sent to the transmitter 1116 for transmission by corresponding ones of the plurality of antennas 1112(1)-1112(M).

The memory 1122 may be a memory device that may include read only memory (ROM), random access memory (RAM), magnetic disk storage media devices, optical storage media devices, flash memory devices, electrical, optical, or other physical/tangible (e.g., non-transitory) memory storage devices. The controller 1120 may be, for example, a microprocessor or microcontroller that executes instructions for the process noise enhancement solution logic 1123 stored in memory 1122. Thus, in general, the memory 1122 may include one or more computer readable storage media (e.g., a memory device) encoded with software including computer executable instructions and when the software is executed (by the controller 1120) it is operable to perform the operations described herein in connection with process logic 1123.

The functions of the controller 1120 may be implemented by logic 1123 encoded in one or more tangible media (e.g., embedded logic such as an application specific integrated circuit, digital signal processor instructions, software that is executed by a processor, etc.), wherein the memory 1122 may store data used for the computations described herein (and/or to store software or processor instructions that are executed to carry out the computations described herein). Thus, the process logic 1123 may be implemented with fixed logic or programmable logic (e.g., software/computer instructions executed by a processor) and the controller 1120 may be a programmable processor, programmable digital logic (e.g., field programmable gate array) or an application specific integrated circuit (ASIC) that includes fixed digital logic, or a combination thereof. Some or all of the controller functions described herein, such as those in connection with the process logic 1123, may be implemented in the modem 1118.

While the systems and methods have been described in terms of what are presently considered to be specific aspects, the application need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

What is claimed is:

1. A method comprising:
rotating a plurality of calibration signals received from a plurality of antennas of a radio unit to obtain different phases, associated with the plurality of calibration signals, configured to cause non-coherent combining of noise of the plurality of calibration signals;
combining the plurality of calibration signals comprising the non-coherent combined noise; and
calibrating at least one antenna of the plurality of antennas based on the combined plurality of calibration signals.

2. The method of claim 1, wherein the noise comprises at least one of phase noise or clipping noise.

3. The method of claim 1, wherein the different phases are such that a sum of transfer functions associated with the different phases equals zero.

4. The method of claim 1, wherein rotating the plurality of calibration signals comprises splitting the plurality of calibration signals into at least two signals comprising different phases.

5. The method of claim 4, wherein rotating the plurality of calibration signals further comprises splitting the at least two signals into at least two other signals comprising the other different phases.

6. The method of claim 1, wherein the different phases comprise angles differing by 360/m degrees, wherein m comprises a number of antennas of the plurality of antennas.

7. The method of claim 1, wherein the different phases of the plurality of calibration signals differ by 90 degrees.

8. A radio unit comprising:
a plurality of antennas; and
at least one combiner configured to:
receive a plurality of calibration signals transmitted from the plurality of antennas;
rotate the plurality of calibration signals to obtain different phases, associated with the plurality of calibration signals, to cause non-coherent combining of noise of the plurality of calibration signals;
combine the plurality of calibration signals comprising the non-coherent combined noise; and
calibrate at least one antenna of the plurality of antennas based on the combined plurality of calibration signals.

9. The radio unit of claim 8, wherein the radio unit comprises a massive multiple-input multiple-output (MIMO) radio unit.

10. The radio unit of claim 8, wherein the radio unit comprises a beamformer.

11. The radio unit of claim 8, wherein the different phases are such that a sum of transfer functions associated with the different phases equals zero.

12. The radio unit of claim 8, wherein the at least one combiner is configured to cause the non-coherent combining of the noise by splitting the plurality of calibration signals into at least two signals comprising different phases.

13. The radio unit of claim 12, wherein the at least one combiner is further configured to split the at least two signals into at least two other signals comprising other different phases.

14. The radio unit of claim 8, wherein the different phases comprise angles differing by 360/m degrees, wherein m comprises a number of antennas of the plurality of antennas.

15. The radio unit of claim 8, wherein the different phases of the plurality of calibration signals differ by 90 degrees.

16. A combiner configured to:
rotate a plurality of calibration signals received from a plurality of antennas of a radio unit to obtain different phases, associated with the plurality of calibration signals, configured to cause non-coherent combining of noise of the plurality of calibration signals;
combine the plurality calibration signals comprising the non-coherent combined noise; and
calibrate at least one antenna of the plurality of antennas based on the combined plurality of calibration signals.

17. The combiner of claim 16, further configured to calibrate, based on the non-coherent combined noise from the combined plurality of calibration signals, the plurality of antennas.

18. The combiner of claim 16, wherein the noise comprises at least one of phase noise or clipping noise.

19. The radio unit of claim 16, wherein the combiner is configured to cause the non-coherent combining of the noise by splitting the plurality of calibration signals into at least two signals comprising different phases.

20. The radio unit of claim 19, wherein the combiner is further configured to split the at least two signals into at least two other signals comprising other different phases.
